(19) United States
(12) Patent Application Publication
(10) Pub. No.: US 2026/0088478 A1
(43) Pub. Date: Mar. 26, 2026

(54) PHASE SHIFTER ASSEMBLY AS WELL AS ANTENNA

(71) Applicant: Telefonaktiebolaget LM Ericsson (publ), Stockholm (SE)

(72) Inventor: Jan Grävendieck, Rosenheim (DE)

(21) Appl. No.: 19/110,086

(22) PCT Filed: Oct. 25, 2022
(86) PCT No.: PCT/EP2022/079812

§ 371 Date: Mar. 9, 2025

(51) Int. Cl. H01P 1/18; H01Q 1/24; H01Q 3/32; H01Q 19/10

(52) U.S. Cl. CPC H01P 1/184; H01Q 1/246; H01Q 3/32; H01Q 19/108

(57) ABSTRACT

A phase shifter assembly has two signal conductors, a ground plane, a substrate, a shifting device, and a cover. The signal conductors are located on the front surface and each comprise a delay section. The shifting device comprises an actuation portion and two shifting portions, the shifting portions being located at the front side of the substrate and covering one of the delay sections of the signal conductor at least partly. The shifting device is movable with respect to the substrate. The substrate comprises a slot vertically through the substrate, wherein the slot is located between the delay sections of the at least two signal conductors, and wherein the actuation portion of the shifting device extends through the slot. The cover is located on the front side of the substrate covering the slot and being electrically connected to the ground plane. Further, an antenna is provided.

### TECHNICAL FIELD

The invention relates to a phase shifter assembly for radio frequency signals as well as an antenna comprising a phase shifter assembly.

### BACKGROUND

Antenna arrays for mobile communication make use of phase shifters to tilt the beam. Some radiofrequency applications need analog phase shifters having a shifting device that needs to be shifted mechanically in order to create the necessary phase shift for tilting the beam.

Further, the phase shifters have to be arranged close to the radiators so that linear phase shifters on substrates have been developed to simplify the arrangement of the phase shifter assemblies between columns of radiators.

Such phase shifter assemblies are known, for example, from US 2009/0278761 A1 and CN 113328217 A.

The known solutions, however, require much space on the surface of the substrate of the phase shifter assembly to accommodate for the actual phase shifting components and the actuation for these components.

### SUMMARY

It is therefore an object of the invention to provide a phase shifter assembly as well as an antenna requiring less space on a surface of a substrate without deterioration of signal quality.

For this purpose, a phase shifter assembly for radio frequency signals, in particular mobile communication signals, is provided. The phase shifter assembly comprises at least two signal conductors, a ground plane, a substrate with a front surface and a rear surface, a shifting device, and a cover. The at least two signal conductors are located on the front surface and each of the at least two signal conductors comprises a delay section, and wherein the ground plane is provided at the rear surface of the substrate. The shifting device comprises an actuation portion and two shifting portions, the shifting portion being located at the front side of the substrate and each of the two shifting portions covering one of the at least two delay sections of the signal conductor at least partly, wherein the shifting device is movable with respect to the substrate in a direction of motion parallel to the front surface. The substrate comprises a slot extending in the direction of motion and vertically through the substrate and the ground plane, wherein the slot is located between the delay sections of the at least two signal conductors with respect to the direction of motion. The actuation portion of the shifting device extends from the shifting portion through the slot. The cover is located on the front side of the substrate covering the slot at least in the vertical direction, wherein the cover is electrically connected to the ground plane.

By providing a slot in the substrate, the shifting device is accessible from the rear side of the substrate, allowing actuation from the rear side. Thus, components for actuating the shifting device, for example an actuation mechanism, may be arranged at a different side of the substrate than the signal conductor. The space required on a single surface, in particular on the front surface, is therefore drastically reduced.

At the same time, the inventors have realized that by providing a cover that covers the slot, the signal quality of the antenna, in which the phase shifter assembly is used, is not deteriorated, as the cover prevents electromagnetic radiation propagating through the slot.

In particular, the cover covers slot fully in vertical direction. No ground plane is present vertically in front or rearwards of the slot.

For example, the cover is fixed to the substrate.

The cover is, for example, galvanically connected to ground plane. Further, the cover may be located in front of shifting device.

The shifting portions may merge into one another and/or the actuation portion may be located centrally between shifting portions.

The shifting device may be movable in such a way that the length of the part of the delays section covered by the shifting portion of the shifting device varies during movement. The direction of motion may coincide with the longitudinal direction of the phase shifter assembly.

In an aspect, the cover closes the slot in the vertical direction and in a transverse direction parallel to the front surface of the substrate and perpendicular to the direction of motion, further improving signal quality.

In particular, closing is understood with respect to radio frequency radiation.

In an embodiment, the cover has a base and sidewalls, wherein the base extends parallel to the front surface of the substrate and/or wherein the sidewalls extend perpendicular to the front surface of the substrate, allowing the cover to be manufactured cost efficiently. In particular, the sidewalls are fixed to substrate.

The cover may have a U-shaped cross section.

For example, the cover extends above the delay sections, wherein the shifting portion of the shifting device is located between the base of the cover and the substrate, thus functioning as a shielding and an additional ground plane for the signal conductor and operates as well as a part of the reflector for the antenna radiators.

In an embodiment, with respect to the transverse direction, the shifting portion comprises a middle section and two outer sections, wherein the outer sections have a rear end extending further to the rear than the middle section, in particular wherein the rear ends of the outer sections have a curved contour. Thus, the shifting portion provides a defined contact surface, reducing the requirements on manufacturing tolerances and minimizing friction.

For example, the middle section is located above the signal conductor and/or the outer sections are in mechanical contact with the substrate and/or the ground plane transversally besides the signal conductor, leading to a precisely adjustable phase shifting device.

In a further aspect, the phase shifter assembly comprises an actuating mechanism located at the rear side of the substrate, wherein the actuating mechanism is mechanically connected to the actuation portion of the shifting device and designed such that it is able to move the shifting device in the direction of motion. This way, the large components providing mechanical actuation do not have to be arranged at the front surface, leading to a further reduced footprint on the front surface.

For a simple and robust actuation of the shifting device, the actuating mechanism may comprise an actuator, in particular an electric motor, and driving structure movable linearly in the direction of motion by the actuator, wherein the driving structure is attached to the actuation portion of the shifting device. In particular, the driving structure is a driving plate.

In order to further improve phase shifting precision, the shifting portions may be made of a dielectric material and/or comprise cutouts.

In particular, the shifting portions are curved rearwards in an unassembled state so that firm mechanical contact to the substrate is guaranteed, leading to very small manufacturing tolerances of the phase shifter assembly.

For a compact design, the delay sections of the signal conductors may be located next to the slot with respect to the direction of motion. In particular, the delay sections lie in an imaginary extension of slot in the direction of motion.

In an embodiment, each one of the delay sections comprises a port located at the end of the respective delay section facing away from the slot with respect to the direction of motion, in particular wherein the at least one port is located outside of the cover, simplifying connections.

The port may be located outside the cover in the direction of motion.

In order to provide a slim phase shifter assembly in the transverse direction, each one of the delay sections may comprise a second port, wherein the second port is located at the end of the respective delay section facing towards the slot with respect to the direction of motion.

The second port may be located transversally from the remaining delay section, in particular transversally outside the cover.

For example, the second ports of the at least two signal conductors are connected by a common input conductor forming a differential phase shifter.

To further simplify the wiring, the delay section may comprise a second port, wherein the second port is located at the end of the delay section facing away from the slot with respect to the direction of motion.

In an aspect, the delay section comprises meanders to further reduce the size of the phase shifter assembly.

For above mentioned purpose, further an antenna is provided, in particular for a mobile communication cell site. The antenna comprises a plurality of radiators, a reflector for the radiators and at least one phase shifter assembly as described above.

The features and advantages discussed with respect to the phase shifter assembly also apply to the antenna and vice versa.

For example, the ground plane of the phase shifter assembly is the reflector for the radiators, in particular wherein the radiators are mounted to the substrate at the front side of the substrate. This way, a very compact antenna with high signal quality is achieved.

In order to further reduce the antenna in size, the antenna may comprise a plurality of phase shifter assemblies, wherein the radiators are arranged in columns parallel to the direction of motion, in particular wherein the covers and the shifting portions of the phase shifter assemblies are located between the radiators of adjacent columns.

In an embodiment, the antenna comprises a plurality of phase shifter assemblies, wherein the actuation portions of two, more than two or all of the phase shifter assemblies is attached to a single driving structure at the rear side of the substrate, the driving structure being movable linearly in the direction of motion by an actuator. This way, the number of components can be reduced.

### BRIEF DESCRIPTION OF THE DRAWINGS

Further features and advantages will be apparent from the following description as well as the accompanying drawings, to which reference is made. In the drawings:

FIG. 1 shows a phase shifter assembly according to an embodiment of the invention in a perspective view,

FIG. 2 shows the phase shifter assembly of FIG. 1 in an exploded view,

FIG. 3 shows a cross-section of the phase shifter along line III-III of FIG. 2,

FIG. 4 shows a shifting device of the phase shifter assembly of FIG. 2 isolated in a side view,

FIG. 5 shows a cross-section of the phase shifter assembly along line V-V of FIG. 2,

FIGS. 6, 7 show a cross section in the longitudinal direction of the phase shifter assembly of FIG. 2 with the shifting device positioned in two different positions,

FIG. 8 shows an antenna according to an embodiment of the invention with a phase shifter assembly according to FIG. 1,

FIG. 9 shows a schematic cross-section along line IX-IX of FIG. 8,

FIG. 10 shows a sectional view of a phase shifter assembly according to a second embodiment of the invention, and

FIGS. 11, 12 show a top view of the substrate of a phase shifter assembly according to a third and fourth embodiment of the invention, respectively.

### DETAILED DESCRIPTION

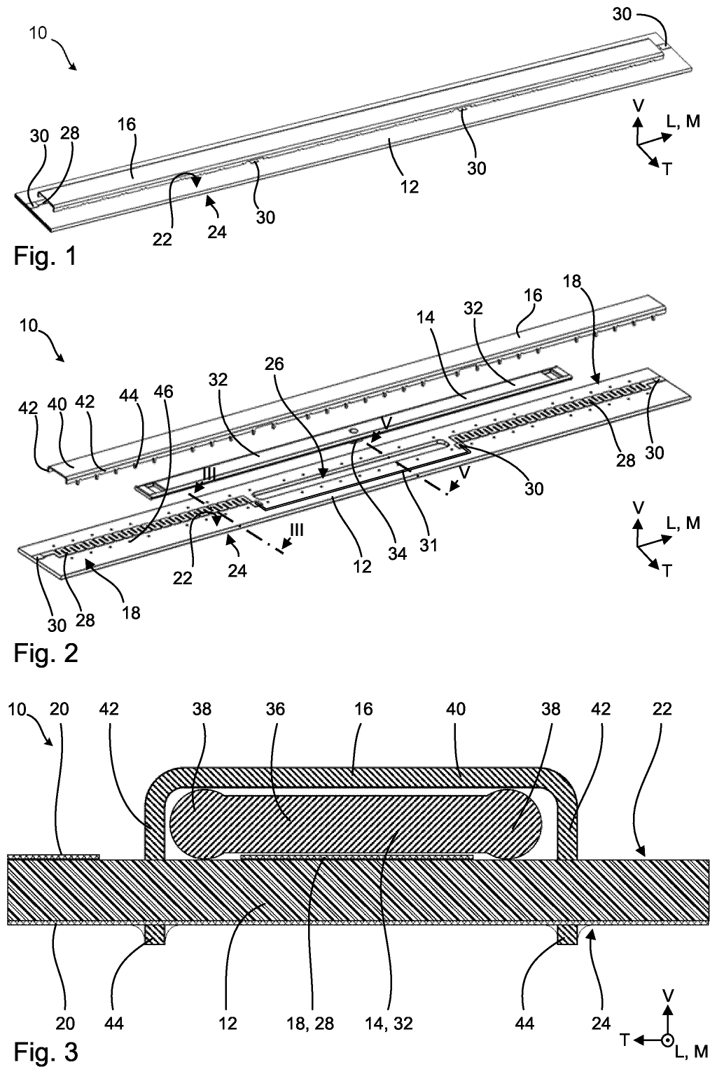

FIGS. 1 and 2 show a phase shifter assembly 10 according to an embodiment of the invention in a perspective view and an exploded view, respectively.

The phase shifter assembly 10 may be configured to be used for radio frequency signals, for example having frequencies between 0.5 GHz and 5 GHz.

The phase shifter assembly 10 comprises a substrate 12, a shifting device 14, a cover 16 as well as a signal conductor 18 and a ground plane 20.

The substrate 12 has a front surface 22 and a rear surface 24.

The substrate 12 is, for example, a PCB. In the shown embodiment, the substrate 12 is a single layer PCB. However, the substrate 12 may also be a multilayered PCB. Solely for the ease of understanding, only a single layer PCB as a substrate 12 is described in the following.

The phase shifter assembly 10 has a vertical direction V, being the direction perpendicular to the surfaces 22, 24 of the substrate 12. Further, the substrate 12 and thus the phase shifter assembly 10 has a longitudinal direction L and a transverse direction T, which are perpendicular to one another and extend parallel to the surfaces 22, 24.

The signal conductor 18 is located on the front surface 22 of the substrate 12. For example, the signal conductor 18 is a metallization applied to the substrate 12.

The ground plane 20 is provided on at least one of the surfaces 22, 24 of the substrate 12, in the shown embodiment on both sides of the substrate 12 as shown in the cross sectional view of FIG. 3. The one or more ground planes 20 are grounded.

In the shown embodiment, the ground plane 20 located at the rear surface 24 covers the entire area of the rear surface 24. The ground plane 20 located at the front surface 22 may cover the majority of the area of the front surface 22 not occupied by other components, in particular by the signal conductor 18.

In the substrate 12, a slot 26 is located. The slot 26 extends vertically through the substrate 12 and in particular no ground plane 20 is present vertically in front or at the rear of the slot 26.

The slot 26 extends in the longitudinal direction L of the substrate 12, i.e. the slot 26 is much longer in the longitudinal direction L than in the transverse direction T.

In the longitudinal direction L, the slot 26 is located between the two signal conductors 18. In the shown embodiment, the signal conductors 18 extend at different sides of the slot 26 with respect to the longitudinal direction L and away from the slot 26.

Each of the signal conductors 18 comprises a delay section 28 having ports 30.

In the shown embodiment, the delay sections 28 are located at an imaginary extension of the slot 26 in the longitudinal direction L and the delay sections 28 are located next to the slot 26.

One of the ports 30 of the delay section 28 of each of the signal conductors 18, called second port for ease of understanding, is located at the end of the delay section 28 facing towards the slot 26, i.e. next to the slot 26. The second ports 30 may be located offset to the slot 26 in the transverse direction T. The second ports 30 are thus located transversally from the remaining delay section 28.

The other one of the ports 30 is located at the end of the delay section 28 facing away from the slot 26.

Between the ports 30, the delay section 28 may comprise meanders, as can be seen in FIG. 2. The meanders are arranged one behind the other in the longitudinal direction L, i.e. the parallel traces of the meanders extend in the transverse direction T.

The second ports 30 of both signal conductors 18 may be electrically connected to one another by a common input conductor 31.

The common input conductor 31 may be a cable or an additional microstrip line applied on the substrate 12. This conductor 31 may also be integrated on the PCB.

By means of the common input conductor 31 that serves as a common input, the phase shifter arrangement 10 forms a differential phase shifter.

It is also conceivable that, instead of the second ports 30, the first ports 30 (i.e. the ports 30 at the end of the delay sections 28 facing away from the slot 26) are connected by the common input conductor 31, even though this arrangement will require longer signal lines.

The shifting device 14 comprises at least one shifting portion 32 and an actuation portion 34.

The actuation portion 34 is, for example, a pin extending vertically rearwards from the at least one shifting portion 32.

The shifting portion 32 is located at the front side of the substrate 12 and the actuation portion 34 extends in the slot 26 in particular fully through the slot 26 to the rear side of the substrate 12.

The shifting portion 32 is made of a dielectric material and it is conceivable that the shifting portion 32 and the actuation portion 34 are made integrally of a single piece of dielectric material.

In the shown embodiment, the shifting device 14 comprises two shifting portions 32 and one actuation portion 34. For example, both shifting portions 32 are made of a single piece.

The shifting portions 32 extend in opposite directions with respect to the longitudinal direction L. In the middle with respect to the longitudinal direction L, the two shifting portions 32 merge into one another and the actuation portion 34 extends from the shifting portions 32 rearwards.

Each of the shifting portions 32 is associated with one of the signal conductors 18. The shifting portions 32 extends above the delay section 28 of the corresponding signal conductor 18, i.e. at the front of the respective delay section 28.

Seen from the front, the shifting portion 32 thus covers at least parts of the delay section 28.

As can be seen in FIG. 3, with respect to the transverse direction T, the shifting portions 32 have a middle section 36 and two outer sections 38. The middle section 36 is located between the outer section 38 in the transverse direction T.

The middle section is located above the signal conductor 18 and the outer sections 38 are located transversally to the signal conductor 18.

The outer sections 38 have at their rear end, i.e. their end facing the substrate 12, a curved contour. In particular, the outer sections 38 have a circular contour.

The rear end of the middle section 36 is flat and offset to the rear end of the outer sections 38 to the front. Thus, the rear end of the outer sections 38 extends further to the rear than the rear end of the middle section 36.

Due to the offset, the outer sections 38 are physically in contact with the front surface 22 of the substrate 12, wherein the middle section 36 is spaced apart from the front surface 22.

The middle sections 36 may be in physical contact with the signal conductor 18, more precisely the delay section 28 or spaced apart from the delay section 28.

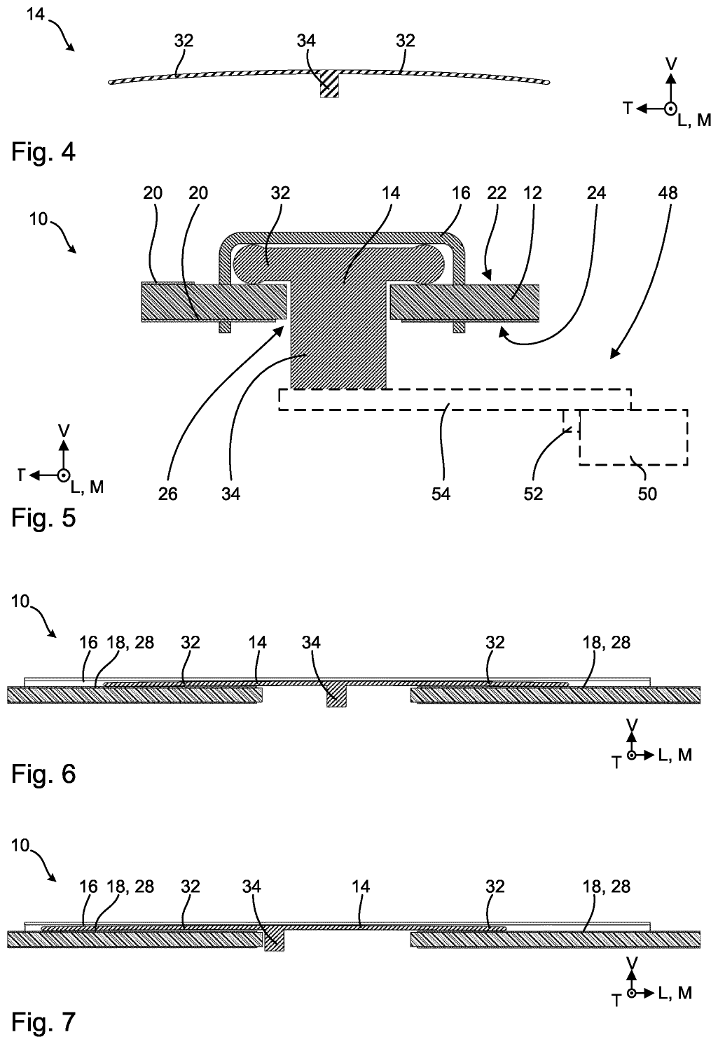

As seen in FIG. 4, the shifting portions 32 may be curved rearwards in an unassembled state so that the shifting portions 32 are pretensions against the front surface 22 of the substrate 12 when assembled.

Further the shifting portion 32, in particular the middle section 36 may comprise cutouts (see FIG. 2), for example so-called transformation windows.

Turning back to FIGS. 2 and 3, the cover 16 is mainly located at the front of the substrate 12 and fixed to the substrate 12.

In the shown embodiment, the cover 16 extends in the longitudinal direction L with a substantially constant cross-section, in particular except for fixation protrusions.

In the transverse direction T, the cover 16 has a base 40 and two sidewalls 42.

The cover 16 is made of a conductive material or provided with a conductive layer or coating.

The base 40 extends in particular parallel to the front surface 22 and is located transversally between the sidewalls 42, wherein the sidewalls 42 extend from the transverse edges of the base 40 rearwards towards the substrate 12, in particular perpendicularly. For example, the cover 16 has a U-shaped cross-section.

The width of the base 40 in the transverse direction T corresponds to the width of the shifting portions 32 in the transverse direction T and/or of that of the slot 26.

The sidewalls 42 are fixed to the substrate 12 affixing the cover 16 to the substrate 12. In the embodiment shown in FIGS. 2 and 3, the sidewalls 42 comprises protrusions 44 at their rear edges that extent rearwardly.

The substrate 12 comprises corresponding openings 46 which may extend fully through the substrate 12 and that corresponds to the protrusions 44 in terms of location and/or size. The protrusions 44 of the sidewalls 42 are inserted in the openings 46 and fixed in place, for example by soldering.

At the same time, the protrusions 44 and/or the sidewalls 42 are galvanically connected to one of the ground planes 20 so that the cover 16 is galvanically connected to the ground plane 20.

In the assembled state shown in FIG. 1, the cover 16, more precisely the base 40, is located vertically above the slot 26 and also above the delay sections 28, thus covering the at least the slot 26 in the vertical direction V.

Also in the longitudinal direction L and the transverse direction T, the cover 16 covers the slot 26 and the delay sections 28 fully, except for the ports 30.

The shifting device 14 and in particular the shifting portions 32 are located between the cover 16, more precisely the base 40 of the cover 16 and the substrate 12.

Further, due to the sidewalls 42, the cover 16 closes the slot 26 also in the transverse direction T.

Also in the longitudinal direction L, the slot 26 is to be regarded as closed due to the distance that the cover 16 extends further than the slot 26.

Closing is to be understood with respect to the radio frequency radiation in the frequency range of the radio signals that the phase shifter assembly 10 is designed for. Thus, due to the closed slot 26, no radio frequency radiation in the frequency range of the radio signals will pass from the rear side to the front side of the substrate 12 and vice versa.

It is also conceivable that at the longitudinal ends of the base 40, further sidewalls are provided like the sidewalls 42.

In the longitudinal direction L, the actuation portion 34 is designed much smaller than the slot 26 so that the shifting device 14 may move back-and-forth relative to the substrate 12 with respect to the longitudinal direction L. Thus, the direction of motion M of the shifting device 14 coincides with the longitudinal direction L. The direction of motion M is also parallel to the front surface 22.

The shifting device 14 is driven via the actuation portion 34 as illustrated in FIG. 5.

FIG. 5 shows a cross-section of the substrate 12, of the phase shifter assembly 10 and of the shifting device 14 along the line V-V of FIG. 2, i.e. at the location of the actuation portion 34. Further, FIG. 5 shows schematically an actuating mechanism 48 of the phase shifter assembly 10 indicated in dashed lines.

The actuating mechanism 48 comprises an actuator 50, a gearing 52 and a driving structure 54.

In the shown embodiment, the driving structure 54 may be plate-shaped and thus be a driving plate.

The driving structure 54 extends parallel to the rear surface 24, and the actuation portion 34 is attached to the driving structure 54 at its rear end, for example by screws.

The actuator 50 may be an electric motor and it is mechanically connected to the driving structure 54 by the gearing 52 in a way that the actuator 50 is able to move the driving structure 54 linearly in the direction of motion M.

Thus, by means of the actuator 50 and the driving structure 54, the actuation portion 34 and thus the entire shifting device 14 is actuated back-and-forth in the direction of motion M.

FIGS. 6 and 7 show two different exemplary positions of the shifting device 14 with respect to the substrate 12 and the cover 16.

In FIG. 6, the shifting device 14 is in the middle position, and in FIG. 7 the shifting device 14 is moved fully to the left. The length of the part of the delay section 28 covered by the respective shifting portion 32 varies depending on the position of the shifting device 14.

Radio frequency signals fed to the delay sections 28 via one of the ports 30 propagate along the respective delay section 28 as the delay sections 28 being enclosed by the grounded cover 16 and optionally by the ground plane 20 located at the rear surface 24 of the substrate 12, thus forming a microstrip or stripline transmission line.

The time the signals need to propagate from one port 30 to the other port 30 through the delay section 28 depends on the length of the delay section 28 covered by the shifting device 14, as the dielectric material of the shifting portion 32 changes the transmission properties compared to portions without the shifting portion 32 present.

Thus, a phase shift can be induced and changed by the movement of the shifting device 14 in the direction of motion M.

Due to the slot 26 and the actuation portion 34, it is possible to arrange the shifting portion 32 on the front side of the substrate 12 and the actuating mechanism 48 at the rear side of the substrate 12. Thus, the space needed at the front side of the substrate 12 can be reduced.

At the same time, due to the cover 16 covering the slot 26 at least vertically, no radio frequency radiation may propagate from the front side to the rear side of the substrate 12 and vice versa so that the reflecting and shielding effect of a fully closed ground plane 20 is achieved despite the ground plane 20 being interrupted by the slot 26.

Thus, a high-quality phase shifter assembly 10 for use in antennas is provided that requires little space at the front side of the substrate and may make use of the rear side of the substrate 12 as well.

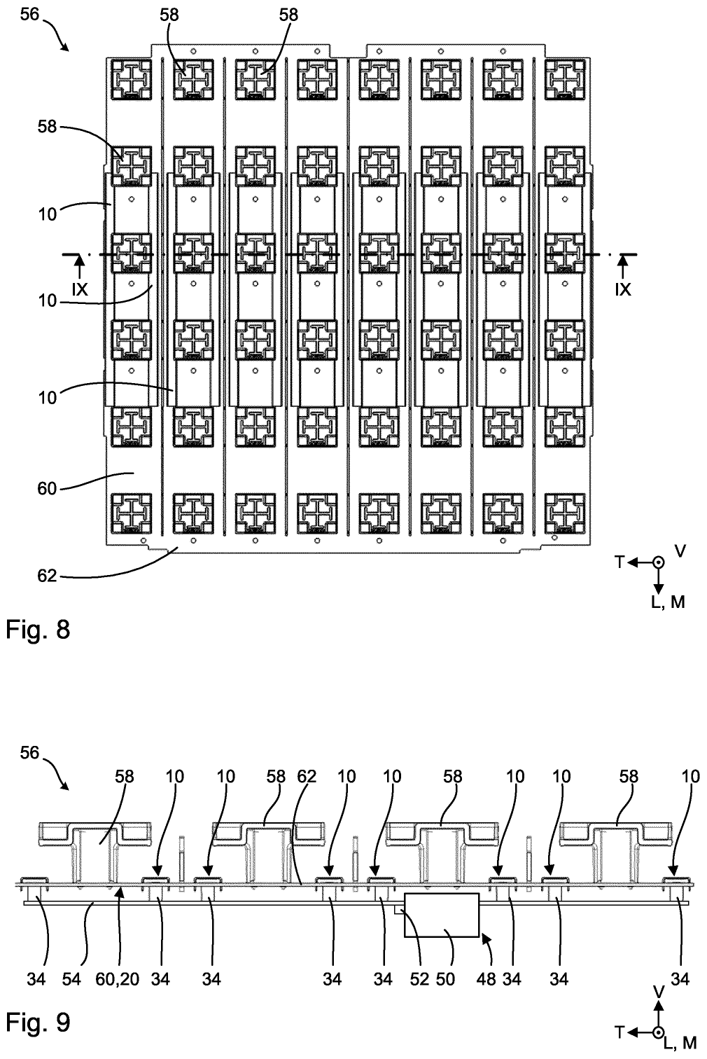

FIGS. 8 and 9 show an antenna 56 according to an embodiment of the invention in a front view and a sectional view along line IX-IX, respectively.

The antenna 56 is, for example, and antenna for mobile communication, in particular for a mobile communication cell site.

The antenna 56 comprises a plurality of radiators 58, a common reflector 60 for the radiators 58 and a plurality of phase shifter assemblies 10 according to an embodiment of the invention.

In the shown embodiment, the radiators 58 are arranged in columns, each column constituting an antenna array with six radiators 58.

Further, each antenna array comprises two phase shifter assemblies 10, as described with respect to the FIGS. 1 to 7.

As seen in FIG. 9, a single substrate 62 is provided, forming the substrate 12 of the phase shifter assemblies 10.

Further, the radiators 58 are mounted to the substrate 62, and are located at the front side of the substrate 62.

As such the single substrate 62 serves as the substrates 12 of the plurality of phase shifter assemblies 10 and simultaneously as the substrate of the antenna array. Thus, the ground plane 20 of the substrate 12, i.e. of the single substrate 62, constitutes also the reflector 60 for the radiators 58.

Thus, the signal conductor 18 is located between the reflector 60 and the radiators 58.

At the front side of the substrate 62, only the covers 16 and the shifting devices 14 of the phase shifter assemblies 10 are present so that the footprint of the phase shifter assemblies 10 on the front side is very small, allowing placement together with the radiators 58.

In the shown embodiment, the covers 16 and slots 26 of the shifting device 14 of the phase shifter assemblies 10 are arranged between the radiators 58 of adjacent columns, parallel to the columns.

Also, the actuating mechanisms 48 of the phase shifter assemblies 10 may be combined to reduce the space needed, albeit on the rear side of the substrate 62.

In the shown embodiment, a single driving structure 54 and a single actuator 50 with a single gearing 52 are provided for all of the phase shifter assemblies 10. As such, the driving structure 54 is attached to the actuation portions 34 of all of the phase shifter assemblies 10 to the effect that the shifting devices 14 may be actuated in unison.

It is also conceivable that each phase shifter assembly 10 comprises its own actuating mechanism 48 or that only two, three or more phase shifter assemblies 10 are actuated by the same actuating mechanism 48.

Due to the phase shifter assemblies 10, very little space is used at the front side of the substrate 62 for the phase shifter assemblies 10 so that a very compact antenna 56 can be provided. Due to the fact that the cover 16 closes the slots 26 in the substrate 62, the radiation quality of the radiators 58 and thus of the antenna 56 is not deteriorated.

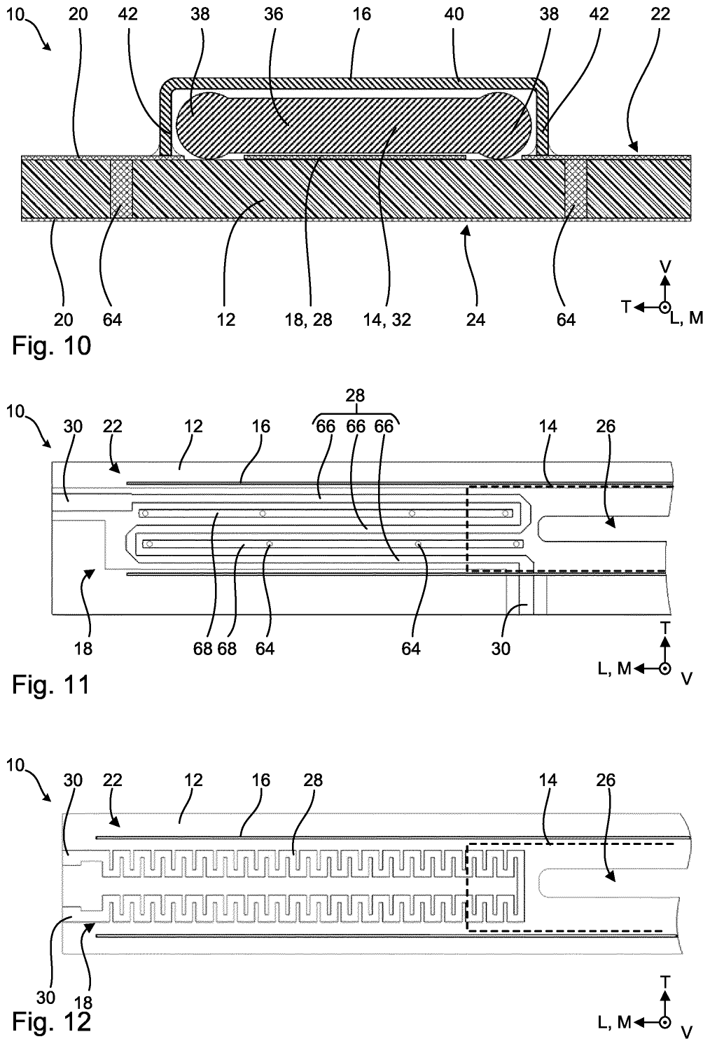

FIGS. 10 to 12 show further embodiments of the phase shifter assembly 10 which substantially correspond to the first embodiment. Thus, in the following, only the differences are discussed and the same and functionally the same components are labeled with the same reference signs.

Further, each of the embodiments may be used in the antenna 56 discussed with respect to FIGS. 8 and 9 and their freely features may be combined.

In the second embodiment shown in FIG. 10, which corresponds to FIG. 3, the cover 16 is provided as a surface mounted device (SMD).

As such, the sidewalls 42 do not comprises protrusions and the substrate 12 does not comprise openings 46. Instead, the sidewalls 42 are attached to the substrate 12 at the front side.

In the shown embodiment, the sidewalls 42 are in physical contact with the ground plane 20 at the front surface 22 and soldered to the ground plane 20.

Further, vias 64 through the substrate 12 are provided that galvanically connect the ground plane 20 at the front surface 22 with the ground plane 20 at the rear surface 24 of the substrate 12.

FIG. 11 shows a third embodiment of the phase shifter assembly 10. FIG. 11 shows a front view onto the substrate 12, wherein only the sidewalls 42 of the cover 16 are shown and the shifting portion 32 is shown only in dashed lines for simplicity.

The third embodiment differs from the first embodiment in that the delay sections 28 have meanders that are arranged one behind the other in the transverse direction T, i.e. the parallel traces 66 of the meanders extend in the longitudinal direction L. In the shown embodiment, only two meanders are present.

Between the parallel traces 66 of the meanders, further pieces 68 of the ground plane 20 are located at the front surface 22 which are connected to the ground plane 20 at the rear surface 24 by vias 64.

The pieces 68 of the ground plane 20 at the front surface 22 between the parallel traces 66 of the delay section 28 have the effect that the traces 66 behave like grounded coplanar waveguides, improving signal quality.

Further, in difference to the first embodiment, the delay section 28 in total, i.e. measured across all meanders, is wider than the slot 26 in the transverse direction T.

Thus, the cover 16, in particular its base 40, and the shifting portion 32 of the shifting device 14 are as well wider in the transverse direction T than in the first embodiment to cover the widened delay section 28.

FIG. 12 shows a fourth embodiment of a phase shifter assembly 10 in a view similar to that of FIG. 11.

In the fourth embodiment, both ports 30 of the delay section 28 are located at the end of the delay section 28 facing away from the slot 26 in the longitudinal direction L.

From both of the ports 30, the delay section 28 extends in two arms as meanders, each similar to that of FIG. 1. At the end of the delay section 28 closest to the slot 26, both arms of meanders are connected.

Like the third embodiment, the total width of the delay section 28 in the transverse direction T, i.e. measured across both sections, is wider than the width of the slot 26 in the transverse direction T.

This way, input and output of the phase shifter assembly 10 may be provided at the same side, simplifying connections.

1. A phase shifter assembly for radio frequency signals, in particular mobile communication signals, comprising at least two signal conductors, a ground plane, a substrate with a front surface and a rear surface, a shifting device, and a cover;
wherein the at least two signal conductors are located on the front surface and each of the at least two signal conductors comprises a delay section, and wherein the ground plane is provided at the rear surface of the substrate;
wherein the shifting device comprises an actuation portion and two shifting portion, the shifting portions being located at the front side of the substrate and each of the two shifting portions covering one of the at least two delay sections of the signal conductor at least partly, wherein the shifting device is movable with respect to the substrate in a direction of motion parallel to the front surface;
wherein the substrate comprises a slot extending in the direction of motion and vertically through the substrate-wherein the slot is located between the delay sections of the at least two signal conductors with respect to the direction of motion, wherein the actuation portion of the shifting device extends from the shifting portion through the slot; and
wherein the cover is located on the front side of the substrate covering the slot at least in the vertical direction, wherein the cover is electrically connected to the ground plane.

2. The phase shifter assembly according to claim 1, wherein the cover closes the slot in the vertical direction and in a transverse direction parallel to the front surface of the substrate and perpendicular to the direction of motion.

3. The phase shifter assembly according to claim 1, wherein the cover has a base and sidewalls, wherein the base extends parallel to the front surface of the substrate and/or wherein the sidewalls extend perpendicular to the front surface of the substrate.

4. The phase shifter assembly according to claim 1, wherein the cover extends above the delay sections, wherein the shifting portion of the shifting device is located between the base of the cover and the substrate.

5. The phase shifter assembly according to claim 1, wherein, with respect to the transverse direction, the shifting portion comprises a middle section and two outer sections, wherein the outer sections have a rear end extending further to the rear than the middle section, in particular wherein the rear ends of the outer sections have a curved contour.

6. The phase shifter assembly according to claim 5, wherein the middle section is located above the signal conductor and/or the outer sections are in mechanical contact with the substrate and/or the ground plane transversally besides the signal.

7. Th phase shifter assembly according to claim 1, wherein the phase shifter assembly comprises an actuating mechanism located at the rear side of the substrate, wherein the actuating mechanism is mechanically connected to the actuation portion of the shifting device and designed such that it is able to move the shifting device in the direction of motion.

8. The phase shifter assembly according to claim 7, wherein the actuating mechanism comprises an actuator in particular an electric motor, and a driving structure movable linearly in the direction of motion by the actuator, wherein the driving structure is attached to the actuation portion of the shifting device.

9. The phase shifter assembly according to claim 1, wherein the shifting portions are made of a dielectric material, comprise cutouts, and/or are curved rearwards in an unassembled state.

10. The phase shifter assembly according to claim 1, wherein the delay sections of the signal conductors are located next to the slot with respect to the direction of motion.

11. The phase shifter assembly according to claim 1, wherein each one of the delay sections comprises a port located at the end of the respective delay section facing away from the slot with respect to the direction of motion, in particular wherein the at least one port is located outside of the cover.

12. The phase shifter assembly according to claim 11, wherein each one of the delay sections comprises a second port wherein the second port is located at the end of the respective delay section facing towards the slot with respect to the direction of motion or is located at the end of the respective delay section facing away from the slot with respect to the direction of motion, in particular wherein the second ports of the at least two signal conductors are connected by a common input conductor.

13. The phase shifter assembly according to claim 1, wherein the delay sections comprise meanders.

14. An antenna, in particular for a mobile communication cell site, comprising a plurality of radiators, a reflector for the radiators, and at least one phase shifter assembly, wherein each phase shift assembly of the at least one phase shifter assembly is for radio frequency signals, in particular mobile communication signals, and comprises at least two signal conductors, a ground plane, a substrate with a front surface and a rear surface, a shifting device, and a cover;
wherein the at least two signal conductors are located on the front surface and each of the at least two signal conductors comprises a delay section, and wherein the ground plane is provided at the rear surface of the substrate;
wherein the shifting device comprises an actuation portion and two shifting portion, the shifting portion being located at front side of substrate and each of the two shifting portions covering one of the at least two delay sections of the signal conductor at least partly, wherein the shifting device is movable with substrate in direction of motion parallel to the front surface;
wherein the substrate comprises a slot extending in the direction of motion and vertically through the substrate, wherein the slot is located between the delay sections of the at least two signal conductors with respect to the direction of motion, wherein the actuation portion of the shifting device extends from the shifting portion through the slot; and
wherein the cover is located on the front side of the substrate covering the slot at least in the vertical direction, wherein the cover is electrically connected to the ground plane.

15. The antenna according to claim 14, wherein the ground plane of the phase shifter assembly is the reflector the radiators and/or wherein the radiators are mounted to the substrate at the front side of the substrate.

16. The antenna according to claim 14, wherein the antenna comprises a plurality of phase shifter assemblies, wherein the radiators are arranged in columns parallel to the direction of motion, in particular wherein the covers and the shifting portions of the phase shifter assemblies are located between the radiators of adjacent columns.

17. The antenna according to claim 14, wherein the antenna comprises a plurality of phase shifter assemblies, wherein the actuation portions of two, more than two, or all of the phase shifter assemblies is attached to a single driving structure at the rear side of the substrate, the driving structure being movable linearly in the direction of motion by an actuator.
